(19) United States
(12) Patent Application Publication
(10) Pub. No.: US 2026/0243208 A1
(43) Pub. Date: Aug. 20, 2026

(54) METHOD FOR SYNCHRONIZING AN INTERNAL COMBUSTION ENGINE ON THE BASIS OF DATA FROM SIGNALS REPRESENTATIVE OF AIR PRESSURE IN CYLINDERS

(71) Applicant: SCHAEFFLER TECHNOLOGIES AG & CO. KG, Herzogenaurach (DE)

(72) Inventors: Charly AMY, Roques (FR); Julien PAYEN, Tournefeuille (FR)

(73) Assignee: SCHAEFFLER TECHNOLOGIES AG & CO. KG, Herzogenaurach (DE)

(21) Appl. No.: 19/370,406

(22) Filed: Oct. 27, 2025

(30) Foreign Application Priority Data
Oct. 28, 2024 (FR) FR2411739

(51) Int. Cl. F02D 41/00; F02B 75/18

(52) U.S. Cl. CPC F02D 41/0087; F02B 75/18; F02D 41/009; F02B 2075/1816; F02D 2200/024

(57) ABSTRACT

A method for synchronizing a four-cylinder internal combustion engine, each cylinder having an air intake pressure sensor, with an actuator making it possible to go from a configuration in which four cylinders are activated to a configuration in which only two cylinders, referred to as active cylinders, are activated. The method begins with the reception of a start signal, then the selection of an engine position assumption. At different angular positions of the crankshaft, air intake pressure values are measured in the two active cylinders. These values are compared with one another in accordance with a predetermined margin to validate or invalidate the assumption. If the assumption is validated in two successive steps, synchronization is attained. If not, the assumption is rejected and the engine is rotated by one revolution of the crankshaft before recommencing the steps until validation.

### CROSS-REFERENCE TO RELATED APPLICATIONS

This application claims priority to French Application No. FR2411739, filed Oct. 28, 2024, the contents of such application being incorporated by reference herein.

### FIELD OF THE INVENTION

The present invention relates to a method for synchronizing starting of an internal combustion engine on the basis of signals representative of air pressure in cylinders.

### BACKGROUND OF THE INVENTION

V engines having a front bank comprising two cylinders and a rear bank comprising two cylinders are known.

Each of the cylinders is equipped with a MAP (manifold air pressure) sensor. These sensors measure the air pressure in the intake manifold of each of the cylinders of the front and rear banks.

Generally, a gasoline combustion engine is synchronized by means of the crankshaft position sensor but, for some applications, synchronization is possible using the signals from the MAP sensors of all the cylinders. In the case at hand, the MAP measurements can serve as a reference for synchronizing the engine during the starting phase. Synchronization consists in determining the position of the engine in the four-stroke cycle (intake, compression, combustion, exhaust).

The MAP signal generated by a cylinder air pressure sensor reaches a bottom level when the piston is at bottom dead center in said cylinder, and at the end of the intake stroke.

These measurements make it possible to identify approximately the mechanical position of each of the cylinders and to deduce therefrom the position of the engine in the four-stroke cycle.

Such an engine (4 cylinders equipped with distribution valve activators) may implement an actuator making it possible to select either a configuration in which the four cylinders are activated or a configuration in which only two of the four cylinders (the front two cylinders in this case) are activated, the other two cylinders being deactivated (i.e. intake and exhaust valves closed and combustion inhibited by stopping injection and possibly ignition).

Given the length of time taken for actuation (crankshaft 720°), the driver may stall the engine during actuation. The position of the camshaft when the engine stops would then be unknown. Stalling the engine is an unpredictable event which cannot be avoided. Not knowing the position of the camshaft when the engine stops can cause a start failure, because the synchronization strategy using MAP sensors waits for pressure signals from all the cylinders (hence 4 signals since it is a 4-cylinder engine).

Any permanent problem with a component of the actuation mechanism (actuator, sensor, camshaft) will result in a downgraded mode which will force the engine to operate on the front two cylinders. This is an option allowing the driver to make it home or to a dealer without damaging the rear cylinders. However, it requires that the engine be restarted on the remaining two cylinders, and for this purpose it is necessary to be able to synchronize the engine on only two cylinders.

If the air pressure sensor is faulty, an emergency strategy is implemented. This strategy attempts to synchronize the engine taking into account only one sensor at a time until it selects a non-faulty sensor. The strategy tests each sensor individually until synchronization is successful. This procedure takes time, because two consecutive acquisitions are needed per sensor and it can take even longer if the faulty sensor is the first on the list to be tested.

Determining the position of the engine needs to be quick and robust for the two start scenarios: with either of the cam profiles; hence the need to propose this new synchronization approach.

### SUMMARY OF THE INVENTION

To this end, a first aspect of the invention relates to a method for synchronizing an internal combustion engine during a start phase, the combustion engine comprising four cylinders, each of the cylinders being associated with an air intake pressure sensor in said cylinder, the engine being associated with a control unit configured to cause the engine to go from a configuration of selection of activation of the four cylinders to a configuration of selection of activation of two of said four cylinders, referred to as active cylinders, and vice versa, the method comprising, in the configuration of activation of two of said four cylinders, the following steps:
receiving an event signal indicating starting of said combustion engine, then
selecting a so-called current combustion engine position assumption on starting from among a plurality of possible assumptions on starting, then
on receiving a signal representative of passage of the crankshaft through a first predetermined angular position, carrying out a first step of acquisition of a first current value of air intake pressure in one, referred to as the first cylinder, of said two active cylinders and a second current value of air intake pressure in the other, referred to as the second cylinder, of said two active cylinders,
executing a first test step to validate or invalidate the current assumption by comparing the first current value and the second current value, as a function of the current assumption and a predetermined margin:
then, in the event of validation of the current assumption by the first test step:
   on receiving a signal representative of passage of the crankshaft through a second predetermined angular position, carrying out a second step of acquisition of a third current value of air intake pressure in said first cylinder and a fourth current value of air intake pressure in said second cylinder, then
   executing a second test step to validate or invalidate the current assumption by comparing the third current value and the fourth current value, as a function of the current assumption and said predetermined margin,
   if the second test step validates the current assumption, a state of synchronization of the engine is reached,
   if not, the assumption is invalidated, the engine is physically rotated by one revolution of the crankshaft, then the steps of the method are repeated.

Preferably, the first predetermined angular position and the second predetermined angular position are phase-shifted by 180°.

The predetermined margin may be adjustable as a function of operating conditions of the engine.

According to one possibility, the two active cylinders are determined on the basis of a signal representative of a rotation of a camshaft of the engine.

Advantageously, the two active cylinders are two cylinders of a front bank of the engine.

A second aspect of the invention relates to an internal combustion engine, the combustion engine comprising four cylinders, each of the cylinders being associated with an air intake pressure sensor in said cylinder, the engine having an actuator configured to cause the engine to go from a configuration of selection of activation of the four cylinders to a configuration of selection of activation of two of said four cylinders, referred to as active cylinders, and vice versa, the engine further comprising a control unit configured to implement a method according to the first aspect of the invention.

A third aspect of the invention relates to a vehicle comprising a combustion engine according to the second aspect of the invention.

### BRIEF DESCRIPTION OF THE DRAWINGS

Further features and advantages of aspects of the invention will become apparent upon reading the following detailed description, which will be more clearly understood with reference to the appended drawings, in which:

FIG. 1 is a schematic view of one embodiment of a vehicle according to an aspect of the invention,

FIG. 2 depicts a method according to an aspect of the invention.

### DETAILED DESCRIPTION OF THE INVENTION

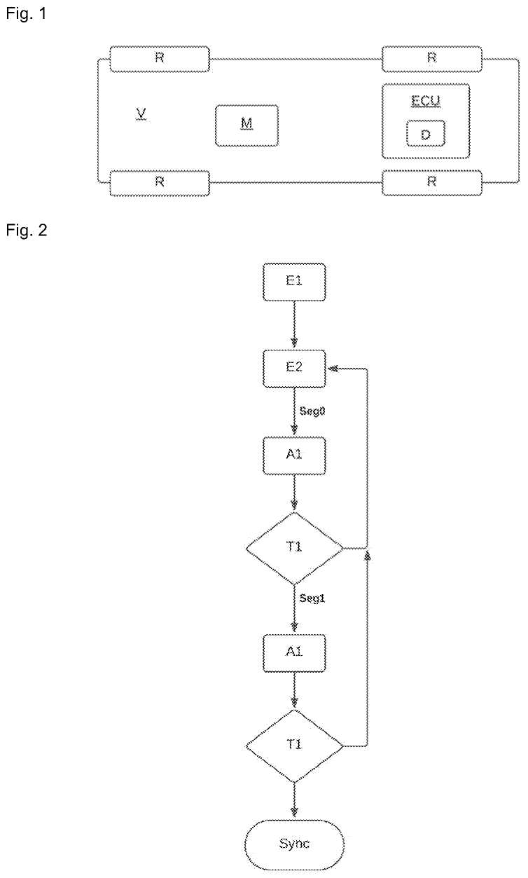

With reference to FIG. 1, this shows a combustion engine M mounted in a vehicle V with wheels R driven by a combustion engine M mounted in said vehicle.

The combustion engine M is an internal combustion engine, for example a four-stroke engine, comprising an intake camshaft and an exhaust camshaft.

The combustion engine M is controlled by an engine control unit, ECU.

The engine is associated with a control unit ECU configured to cause the engine to go from a configuration C1 of selection of activation of the four cylinders to a configuration C2 of selection of activation of two of said four cylinders, referred to as active cylinders, and vice versa.

The engine control unit ECU comprises a device D for controlling the combustion engine M, the device comprising a computer unit (not shown) configured to (see FIG. 2):
receive E1 an event signal indicating starting of said combustion engine, then
select E2 a so-called current combustion engine position assumption on starting from among a plurality of possible assumptions on starting, then
on receiving a signal representative of passage of the crankshaft through a first predetermined angular position Seg0, carry out a first step of acquisition A1 of a first current value P1 of air intake pressure in one, referred to as the first cylinder, of said two active cylinders and a second current value P2 of air intake pressure in the other, referred to as the second cylinder, of said two active cylinders, then
execute a first test step T1 to validate or invalidate the current assumption by comparing the first current value and the second current value, as a function of the current assumption and a predetermined margin.

For the assumption selected, the first test step T1 may for example consist in checking that P1 is greater than P2 and that the difference between the two is greater than the predetermined margin.

If the other assumption was selected, the first test step T1 could have for example consisted in checking that P1 is lower than P2 and that the difference between the two is greater than the predetermined margin.

In the event of validation of the current assumption by the first test step, the computer unit is configured to:
receive a signal representative of passage of the crankshaft through a second predetermined angular position Seg1, carry out a second step of acquisition of a third current value of air intake pressure in said first cylinder and a fourth current value of air intake pressure in said second cylinder, then
execute a second test step to validate or invalidate the current assumption by comparing the third current value and the fourth current value, as a function of the current assumption and said predetermined margin.

For the assumption selected, the second test step T2 may for example consist in checking that P1 is lower than P2 and that the difference between the two is greater than the predetermined margin.

If the other assumption was selected, the first test step T1 could have for example consisted in checking that P1 is greater than P2 and that the difference between the two is greater than the predetermined margin.

If the second test step validates the current assumption, a state of synchronization SYNC of the engine is reached, if not, the assumption is invalidated, the engine is physically rotated by one revolution of the crankshaft, then the steps of the method are repeated.

The first predetermined angular position and the second predetermined angular position may be phase-shifted by 180°. This is the case for example when the signal representative of passage of the crankshaft through the first or the second predetermined angular position corresponding to a “segment” type event.

The predetermined margin may be adjustable as a function of operating conditions of the engine.

The two active cylinders may be determined on the basis of a signal representative of a rotation of a camshaft of the engine.

Complementarily, the two active cylinders may be the two cylinders of a front bank of the engine.

The electronic module D can be implemented in the form of a computer program product, comprising program code instructions recorded on a computer-readable medium such as a processor, a controller, or a microcontroller for implementing the steps of the method P when said program is implemented by said computer such as a processor, a controller, or a microcontroller.

An aspect of the present invention is particularly applicable in the method for controlling an engine equipped with ECD (engine cylinder deactivation) technology, which makes it possible to temporarily deactivate 2 out of 4 cylinders.

As well as being applicable to the field of motorcycles, an aspect of this invention could also be used in other fields such as automotive, nautical and heavy-and medium-duty vehicles.

Of course, an aspect of the invention is not limited to the examples that have been described above, and these examples may be adapted in numerous ways without departing from the scope of the invention. Furthermore, the various features, forms, variants and embodiments of the invention may be combined with one another in various combinations provided they are not incompatible or mutually exclusive.

1. A method for synchronizing an internal combustion engine during a start phase, the combustion engine comprising four cylinders,
each of the cylinders being associated with an air intake pressure sensor in said cylinder,
the engine being associated with a control unit configured to cause the engine to go from a configuration of selection of activation of the four cylinders to a configuration of selection of activation of two of said four cylinders, referred to as active cylinders, and vice versa,
the method comprising, in the configuration of activation of two of said four cylinders, the following steps:
receiving an event signal indicating starting of said combustion engine, then
selecting a so-called current combustion engine position assumption on starting from among a plurality of possible assumptions on starting, then
on receiving a signal representative of passage of the crankshaft through a first predetermined angular position carrying out a first step of acquisition of a first current value of air intake pressure in one, referred to as the first cylinder, of said two active cylinders and a second current value of air intake pressure in the other, referred to as the second cylinder, of said two active cylinders,
executing a first test step to validate or invalidate the current assumption by comparing the first current value and the second current value, as a function of the current assumption and a predetermined margin:
then, in the event of validation of the current assumption by the first test step:
on receiving a signal representative of passage of the crankshaft through a second predetermined angular position carrying out a second step of acquisition of a third current value of air intake pressure in said first cylinder and a fourth current value of air intake pressure in said second cylinder, then
executing a second test step to validate or invalidate the current assumption by comparing the third current value and the fourth current value, as a function of the current assumption and said predetermined margin,
if the second test step validates the current assumption, a state of synchronization of the engine is reached,
if not, the assumption is invalidated, the engine is physically rotated by one revolution of the crankshaft, then the steps of the method are repeated.

2. The synchronization method as claimed in claim 1, wherein the first predetermined angular position and the second predetermined angular position are phase-shifted by 180°.

3. The synchronization method as claimed in claim 1, wherein the predetermined margin is adjustable as a function of operating conditions of the engine.

4. The synchronization method as claimed in claim 1, wherein the two active cylinders are determined on the basis of a signal representative of a rotation of a camshaft of the engine.

5. The synchronization method as claimed in claim 1, wherein the two active cylinders are two cylinders of a front bank of the engine.

6. An internal combustion engine the combustion engine comprising four cylinders,
each of the cylinders being associated with an air intake pressure sensor in said cylinder,
the engine having an actuator configured to cause the engine to go from a configuration of selection of activation of the four cylinders to a configuration of selection of activation of two of said four cylinders, referred to as active cylinders, and vice versa,
the engine further comprising a control unit configured to implement a method as claimed in claim 1.

7. A vehicle comprising a combustion engine as claimed in claim 6.
